(19) United States
(12) Patent Application Publication
(10) Pub. No.: US 2014/0191004 A1
(43) Pub. Date: Jul. 10, 2014

(54) UNIVERSAL GUNWALE BRACKET

(71) Applicant: Yakima Innovation Development Corporation, (US)

(72) Inventors: Ross M. Miyao, Sherwood, OR (US); Juan H. Cagampang, Portland, OR (US)

(73) Assignee: Yakima Innovation Development Corporation, Georgetown Grand Cayman (KY)

(21) Appl. No.: 13/861,260

(22) Filed: Apr. 11, 2013

Related U.S. Application Data
(60) Provisional application No. 61/640,625, filed on Apr. 30, 2012.

(51) Int. Cl. B60R 9/08

(52) U.S. Cl. CPC B60R 9/08
USPC 224/331

(57) ABSTRACT

An apparatus for carrying a boat is disclosed. In some examples, the apparatus may include a crossbar, a pair of towers for coupling the crossbar to a vehicle, a gunwale support device configured to support a gunwale of the boat, and a clamp device coupled to the gunwale support device configured to selectively grip crossbars of various sizes and shapes. The gunwale support device may include a bench having a seat (or seat surface), a back (or back wall surface), and a top surface on which the gunwale and/or other portion of the boat may be supported. The seat, back wall, and/or top surfaces may be convexly curved, tapered, angled, and/or have a progressive curvature corresponding to a curved portion of a cone, which may compensate for misalignment between the gunwale and the bench. The clamp device may include an actuator located above the crossbar for manipulating the clamp device between open and clamped positions. The back may define a plane substantially perpendicular to a core axis of the crossbar, and a portion of the bench and the actuator may be on opposite sides of the plane.

### CROSS-REFERENCES TO RELATED APPLICATIONS

This application claims priority from U.S. Provisional Patent Application Ser. No. 61/640,625, filed Apr. 30, 2012, which is incorporated herein by reference. Also incorporated herein by reference in their entireties are U.S. Patent Applications and U.S. Pat. Nos. 7357283; 8136708; 2009/0120981; and 2010/0078454.

### INTRODUCTION

People frequently carry cargo on vehicles. Specialized racks are available for securing recreational items typically on top or on the rear of vehicles. Carrying cargo outside the vehicle is a convenient way to increase carrying capacity, particularly considering current trends to drive smaller more fuel efficient vehicles, and particularly with respect to inherently large items that usually don't fit well inside a vehicle, for example, boats, bikes, skis, and surf and paddle boards.

Some cargo items require straps to bind things to a rack or to an external surface of a vehicle. For example, straps are typically used to help position and/or secure boats and surfboards on top of vehicles. In some instances, a bracket is needed to secure the strap to the external surface of the vehicle, such as the rack. Such brackets may make it easy to load and transport cargo, such as a boat or canoe, on a rack. These types of brackets, when used to hold a gunwale of a boat or a canoe, may be referred to as gunwale brackets.

### BRIEF DESCRIPTION OF THE DRAWINGS

FIG. 1 is a perspective view of a rack on the roof of a vehicle.

FIG. 2 is a perspective view of two opposing gunwale brackets secured to a crossbar.

FIG. 3 is an exploded perspective view of a gunwale bracket of FIG. 2.

FIG. 3A is a bottom view of the gunwale bracket of FIG. 3

FIG. 4 is a front view of the gunwale bracket of FIG. 3.

FIG. 5 is a top view of the gunwale bracket of FIG. 3.

FIG. 5A is a side view of the gunwale bracket of FIG. 3.

FIG. 6 is a perspective view of an alternative embodiment of a gunwale bracket secured to a crossbar.

FIG. 7 is an exploded perspective view of the gunwale bracket of FIG. 6.

### DETAILED DESCRIPTION

This disclosure provides numerous selected examples of invented devices for carrying cargo on or with a vehicle. Many alternatives and modifications which may or may not be expressly mentioned, are enabled, implied, currently possessed, and are therefore supported by the disclosure.

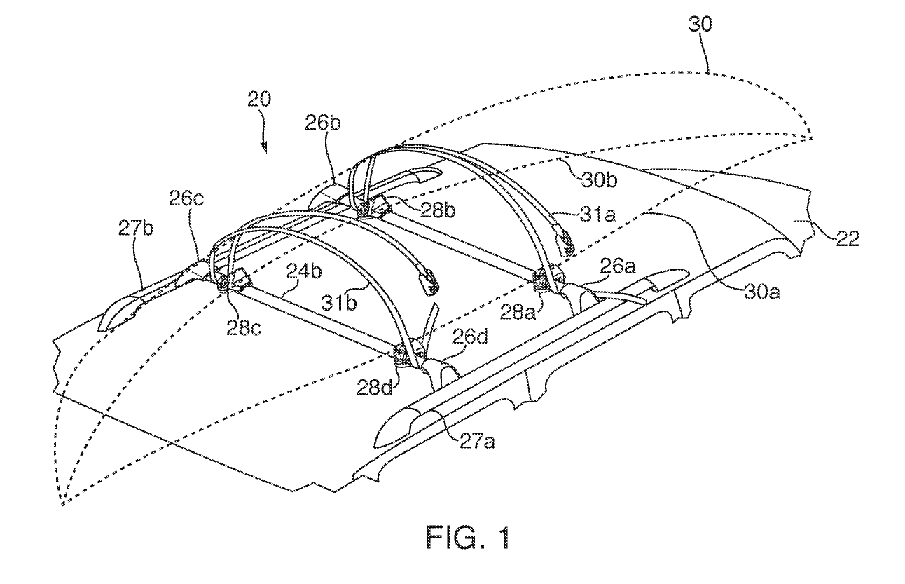

FIG. 1 shows a rack 20 configured for carrying cargo 30 on a vehicle 22. Rack 20 may include a pair of crossbars 24a, 24b; towers 26a-d that may clamp crossbars 24a, 24b to roof rails 27a, 27b in an orientation perpendicular to an elongate axis of vehicle 22; gunwale bracket mechanisms 28a-d that may be secured to crossbars 24a, 24b in opposing pairs to support opposing gunwales 30a, 30b of a boat 30 (shown in phantom); and strap mechanisms 31a, 31b that may secure boat 30 to gunwale bracket mechanisms 28a-d. As shown, gunwale bracket mechanisms 28a, 28d may be identical in structure, and gunwale bracket mechanisms 28b, 28c may be identical in structure, which may respectively mirror the structure of gunwale bracket mechanisms 28a, 28d. Alternatively, the relative positions of gunwale bracket mechanisms 28a, 28b may be reversed on crossbar 24a, and the relative positions of gunwale bracket mechanisms 28c, 28d may be reversed on crossbar 24b to support opposing gunwales 30a, 30b from the “inside” rather than the “outside” of boat 30, which may allow for rack 20 to carry a larger boat.

Preferentially, rack 20 may include a set of two “left” or “driver-side” gunwale brackets (e.g., gunwale brackets 28b, 28c) and two “right” or “passenger-side” gunwale brackets (e.g., gunwale brackets 28a, 28d). Placing the gunwale brackets on the crossbars so that the actuator of each gunwale bracket (shown here as a knob) faces toward the back of the vehicle may provide rack 20 with a more aerodynamic profile and/or reduce the likelihood that the gunwale brackets might break off of the crossbars in the case of a sudden vehicular impact.

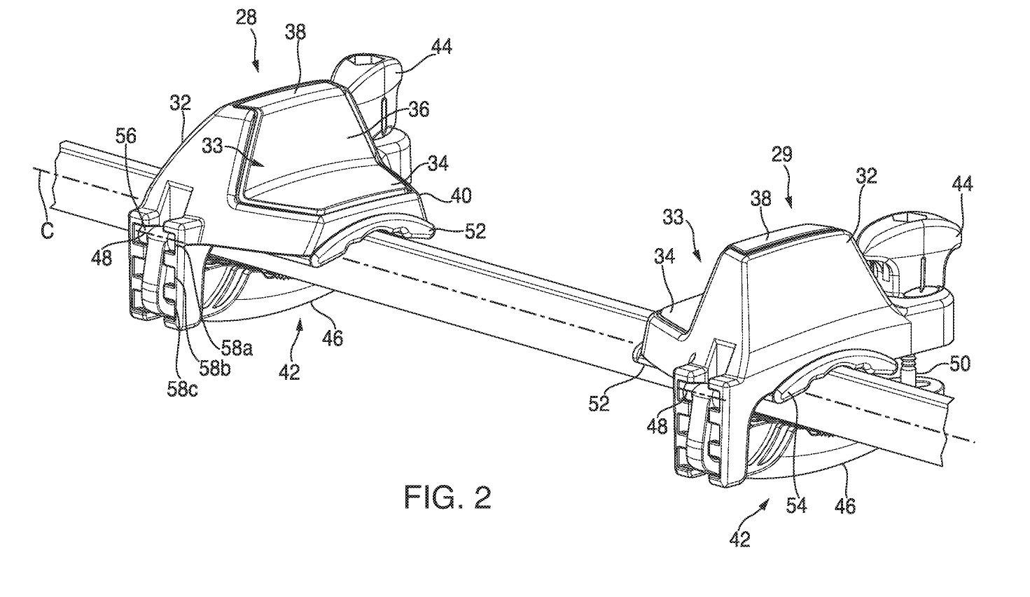

FIG. 2 shows gunwale bracket mechanisms 28, 29 opposingly secured to an aerodynamically shaped crossbar so as to support opposing gunwales of a boat. Gunwale bracket mechanism 28 may represent any one of gunwale bracket mechanisms 28a-d of FIG. 1, and gunwale bracket mechanism 29 may mirror the structure of gunwale bracket mechanism 28 (as shown). As shown, gunwale bracket 28 is a “right” or “passenger-side” gunwale bracket, and gunwale bracket 29 is a “left” or “driver-side” gunwale bracket.

As described above, gunwale brackets 28, 29 may be switched on the crossbar to support inside gunwales of the boat. For example, gunwale bracket 28 may be placed on the crossbar where gunwale bracket 29 is shown in FIG. 2, and gunwale bracket 29 may be placed on the crossbar where gunwale bracket 28 is shown in FIG. 2. Alternatively, the orientation of each gunwale bracket may be switched on the crossbar to support inside gunwales by placing the actuator side of each bracket mechanism towards the front of the vehicle.

Each gunwale bracket mechanism may include a gunwale support device 32, which may include any suitable structure and/or apparatus configured to support a gunwale of a boat. For example, gunwale support device 32 may include a bench 33 that may have a seat or seat surface 34, a back or back wall surface 36, and a top surface 38. Seat 34, back 36, and/or top surface 38 may be configured to support the gunwale and/or other portion of the boat.

Seat 34 may be substantially parallel to a core axis C of the crossbar and may extend from and/or be connected to a lower or bottom portion of back 36. Seat 34 may form an angle with core axis C of the crossbar of approximately 5-10 degrees. Seat 34 may have a tapered width, and may be convexly curved about a radius originating below core axis C of the crossbar. Seat 34 may have a progressive curvature, which may correspond to a curved portion of a cone.

Back 36 may be substantially perpendicular to seat 34, and may define a plane substantially perpendicular to core axis C of the crossbar. Back 36 may form an angle with a plane perpendicular to core axis C of the crossbar of approximately 5-10 degrees. Back 36 may form an angle with core axis C of the crossbar of approximately 95-100 degrees. Back 36 may have a tapered width, and may be convexly curved about a radius originating below core axis C of the crossbar. Back 36 may have a progressive curvature, which may correspond to a curved portion of a cone.

Top surface 38 may be substantially parallel to core axis C of the crossbar, and may extend from and/or be connected to an upper portion of back 36. Top surface 38 may have a tapered width, and may be convexly curved about a radius originating below core axis C of the crossbar.

Gunwale support device 32 may include a compressible pad layer 40, which may run continuously along seat surface 34, back wall surface 36, and top surface 38. Compressible pad layer 40 may be made from elastomer, or any suitable compressible material, or combination thereof. Seat surface 34, back wall surface 36, and/or top surface 38 may be made of a material that provides a relatively high coefficient of friction (e.g., a coefficient of friction greater than or equal to 1) between surface 34, 36, and/or 38 and the gunwale of the boat, which may help to secure the boat to the rack.

Each gunwale bracket mechanism may include a clamp device 42 coupled to gunwale support device 32, which may include any suitable mechanism, structure, and/or apparatus configured to grip the crossbar. For example, clamp device 42 may include an actuator 44 for manipulating clamp device 42 between open and clamped positions, which may involve pivotation of a bail 46 about a pivot axis 48. As shown, pivot axis 48 may be parallel to core axis C of the crossbar.

Actuator 44, shown in FIG. 2 as a knob, may be disposed above core axis C of the crossbar. A post or shaft 50 may connect bail 46 to gunwale support device 32. As shown, post 50 may be threaded. Actuator 44 may be disposed on an end portion of post 50 and may be opposite core axis C from pivot axis 48. Manipulation of actuator 44 away from bail 46 along the threads of post 50 may cause bail 46 to pivot away from gunwale support device 32 about pivot axis 48 to move clamp device 42 towards the open position. Manipulation of actuator 44 towards bail 46 along the threads of post 50 may cause bail 46 to pivot towards gunwale support device 32 about pivot axis 48 to move clamp device 42 towards the clamped position.

In the open position, gunwale bracket mechanism 28 may be configured to be slideable on the crossbar. In the clamped position, gunwale bracket mechanism 28 may be configured to grip the crossbar. For example, gripping the crossbar may involve gripping the crossbar between bail 46 and first and second pad portions 52, 54. A portion of bail 46, first pad portion 52, and/or second pad portion 54 may be made of material with a high coefficient of friction, such as rubber having a coefficient of friction greater than 1.

Bail 46, first pad portion 52, and/or second pad portion 54 may be configured to grip a wide range of crossbar shapes. For example, bail 46, first pad portion 52, and/or second pad portion 54 may be contoured to selectively secure a round crossbar, a square crossbar, or any other suitable crossbar.

Pivot axis 48 may be configured to be an adjustable pivot axis, which may allow each of gunwale bracket mechanisms 28, 29 to be secured to various crossbar shapes and/or sizes. For example, pivot axis 48 may include an enlarged member 56 selectively insertable into any one slot of a plurality of slots 58a, 58b, 58c, which may form an adjustable pivot axis.

FIG. 2 shows enlarged member 56 selectively inserted into slot 58a. However, enlarged member 56 may be selectively inserted into either of slots 58b or 58c to secure gunwale bracket mechanism 28 to a larger or otherwise shaped crossbar, for example.

FIG. 2 shows clamp device 42 as including three slots formed in gunwale support device 32 and enlarged member 56 attached to bail 46. Alternatively, only one slot, two slots, or more than three slots may be formed in gunwale support device 32 for receiving enlarged member 56. Alternatively, either of gunwale bracket mechanisms 28, 29 may include one or more slots formed in bail 46 and an enlarged member attached to gunwale support device 32. Each of these slots may be configured to frictionally, releasabley, and/or pivotally receive enlarged member 56.

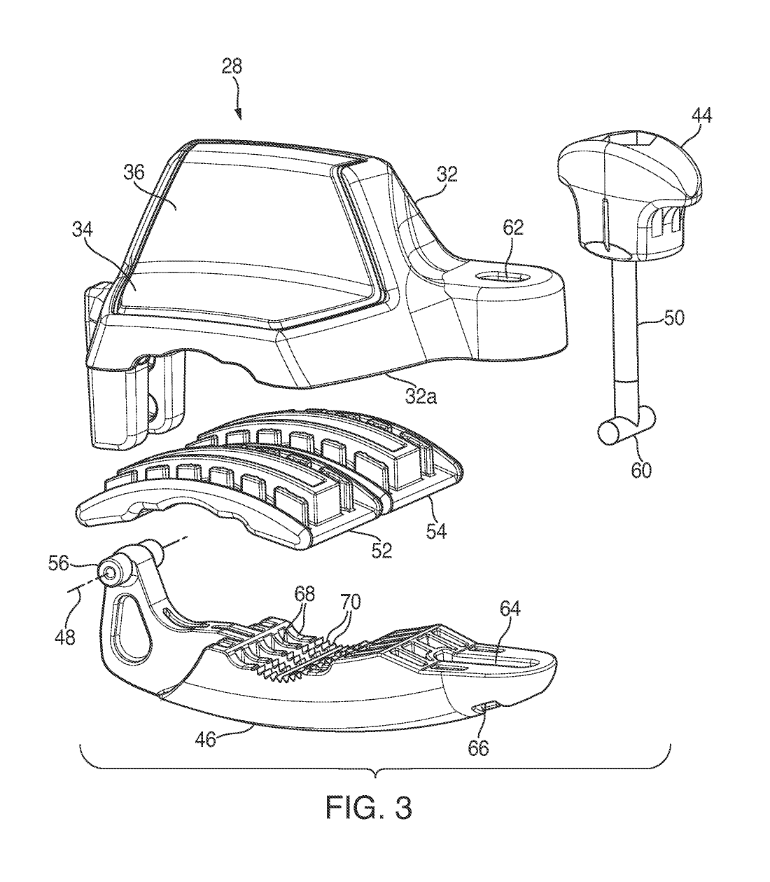

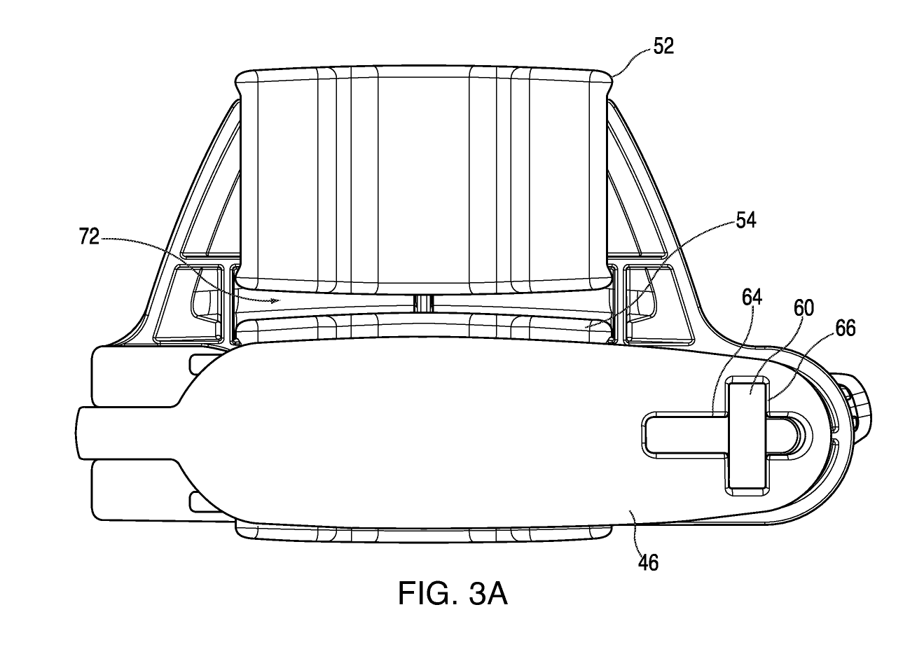

FIG. 3 shows an exploded view of gunwale bracket mechanism 28. Gunwale bracket mechanism 28 may include any structure, apparatus, or mechanism for manipulating bail 46 between the open and clamped positions. For example, post 50 may include a t-bar 60 that may be inserted serially through an aperture 62 in gunwale support device 32 and an aperture 64 in bail 46. Post 50 may then be rotated and t-bar 60 may be seated in a recess 66, which may be transverse to aperture 64. Manipulation of actuator 44 may then pull or release bail 46 towards or away from gunwale support device 32. As shown, apertures 62 and 66 may be elongate in a direction substantially parallel to a longitudinal direction of the bail and/or substantially parallel to the core axis of the crossbar.

Gunwale bracket mechanism 28 may include any structure configured to prevent gunwale bracket mechanism 28 from sliding on the crossbar in the clamped position. For example, first and second pad portions 52, 54 may be connected to or disposed on a lower portion 32a of gunwale support device 32. Second pad portion 54 may be disposed on lower portion 32a such that pivotation of bail 46 causes the crossbar to be clamped or gripped between bail 46 and second pad portion 54, which may also compress first and second pad portions 52, 54 and/or cause first and second pad portions 52, 54 to grip the crossbar. First pad portion 52 may be disposed on lower portion 32a under seat 34, such that downward forces exerted by the boat pressing on seat 34 may compress first pad portion 52 more, less than, or equal to second pad portion 54. Configuring first and second pad portions 52, 54 to allow for differential compression caused by bail 46 and/or the boat may prevent gunwale bracket mechanism 28 from loosening on the crossbar when in the clamped position.

A portion of bail 46 may have a plurality of ridges 68, which may each have a plurality of teeth 70. Ridges 68 may extend substantially perpendicular to the core axis of the crossbar, and may increase translational frictional forces between bail 46 and the crossbar to reduce the likelihood that gunwale bracket mechanism 28 will translate on the crossbar when in the clamped position. Teeth 70 may point substantially radially towards the core axis of the crossbar, and may increase rotational frictional forces between bail 46 and the crossbar to reduce the likelihood that gunwale bracket mechanism 28 will rotate on the crossbar when in the clamped position.

FIG. 3 shows enlarged member 56 as a cylindrical bar attached to bail 46. Alternatively, enlarged member 56 may be spherical, spheroid, oval, or any other suitable shape for being received in a slot and pivoted about an axis.

FIG. 3A shows a bottom view of gunwale bracket mechanism 28. T-bar 60 is shown seated in recess 66. Recess 66 may be proportioned for receiving and releasably securing t-bar 60. Aperture 64 is shown having a length that is greater than a length of t-bar 60, which may allow for t-bar 60 to be inserted through aperture 64 in various states of pivotation of bail 46 (e.g., bail 46 pivoted further from gunwale support device 32 may angle aperture 64 non-perpendicularly to post 50, which may reduce an effective size tolerance for receiving t-bar 60).

A compression gap 72 may be disposed between first and second pad portions 52, 54, which may allow for an improved differential compression of first and second pad portions 52, 54. Examples of differential compression include securing bail 46 to the crossbar without the gunwale resting on gunwale support device 32, which may compress second pad portion 54 more than first pad portion 52; and supporting the gunwale on gunwale support device 32 before securing bail 46 to the crossbar, which may compress first pad portion 52 more than second pad portion 54. Compression gap 72 may isolate first pad portion 52 from second pad portion 54, and may allow for first and second pad portions 52, 54 to expand laterally along the crossbar when compressed, which may increase frictional forces between first and second pad portions 52, 54 and the crossbar. As indicated, a majority of first pad portion 52 may be disposed directly under the seat, and a majority of second pad portion 54 may be disposed directly over bail 46 (but opposite the crossbar from bail 46).

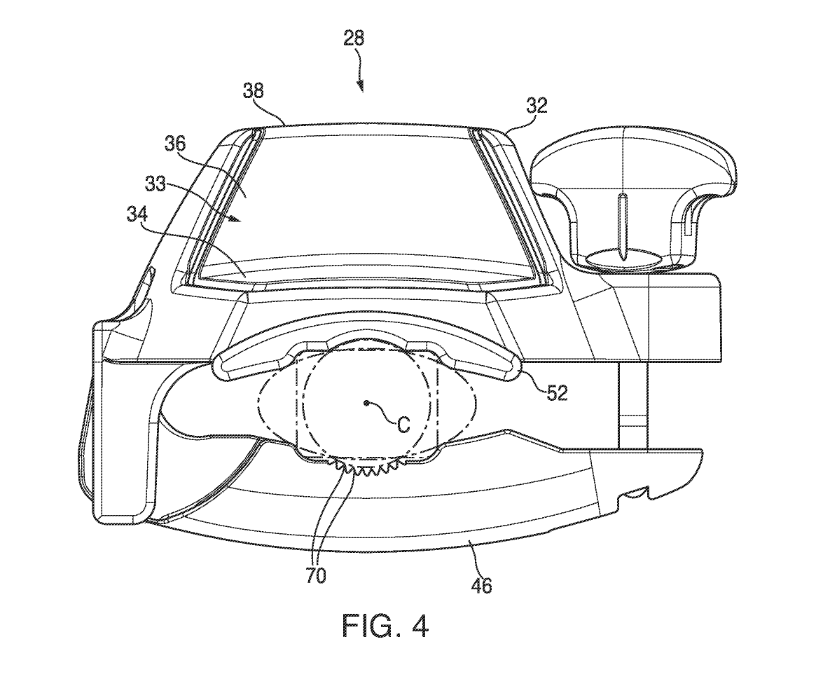

FIG. 4 shows a front view of gunwale bracket mechanism 28. First pad portion 52, second pad portion 54 (not shown here, though may be contoured similarly to first pad portion 52), teeth 70, and a portion of bail 46 may be contoured to selectively grip a variety of crossbar shapes and sizes (shown here in phantom), including a round crossbar, a rectangular crossbar, a square crossbar, and an aerodynamically shaped crossbar, among others.

Surfaces 34, 36, and/or 38 may include any suitable structure for compensating for misalignment between the gunwale of the boat and gunwale support device 32. For example, surfaces 34, 36, and/or 38 may be convexly curved, which may increase the likelihood that the gunwale and/or other portion of the boat will contact gunwale support device 32 directly above the crossbar and/or will have greater contact with surfaces 34, 36, and/or 38. As shown, seat surface 34 and top surface 36 may each be convexly curved with a relatively large radius of curvature originating below the crossbar. Seat surface 34 may have a progressive curvature corresponding to a curved portion of a cone. For example, the radius of curvature of seat surface 34 proximal back wall surface 36 may be larger than the radius of curvature of seat surface 34 distal back wall surface 36, which may provide an increase in contact and/or an increased frictional force between the gunwale and seat surface 34 as the user moves the gunwale towards back wall surface 36 along seat surface 34.

Surfaces 34, 36, and/or 38 may be tapered, which may increase a frictional force between the gunwale and the respective surface as the gunwale moves from a wider to a narrower portion of that surface. As shown, seat surface 34 may be tapered such that a portion of seat surface 34 proximal back wall surface 36 is wider than a portion of seat surface 34 distal back wall surface 36, which may provide an increased frictional force between seat surface 34 and the gunwale as the user moves the gunwale towards back wall surface 36 along seat surface 34; and back wall surface 36 may be tapered such that a portion of back wall surface 36 proximal seat surface 34 is wider than a portion of back wall surface 36 distal seat surface 34, which may provide an increase in contact and/or an increased frictional force between back wall surface 36 and the gunwale as the user moves the gunwale towards seat surface 34 along back wall surface 36.

Preferably, a user may secure gunwale bracket mechanism 28 on the crossbar so that the gunwale of the boat rests on bench 33 and contacts both floor surface 34 and back wall surface 36. By increasing the frictional force and contact between the gunwale and surfaces 34, 36 in a region proximal to both surfaces 34, 36, as described above, the likelihood of the boat inadvertently coming off of gunwale support device 32 may be reduced.

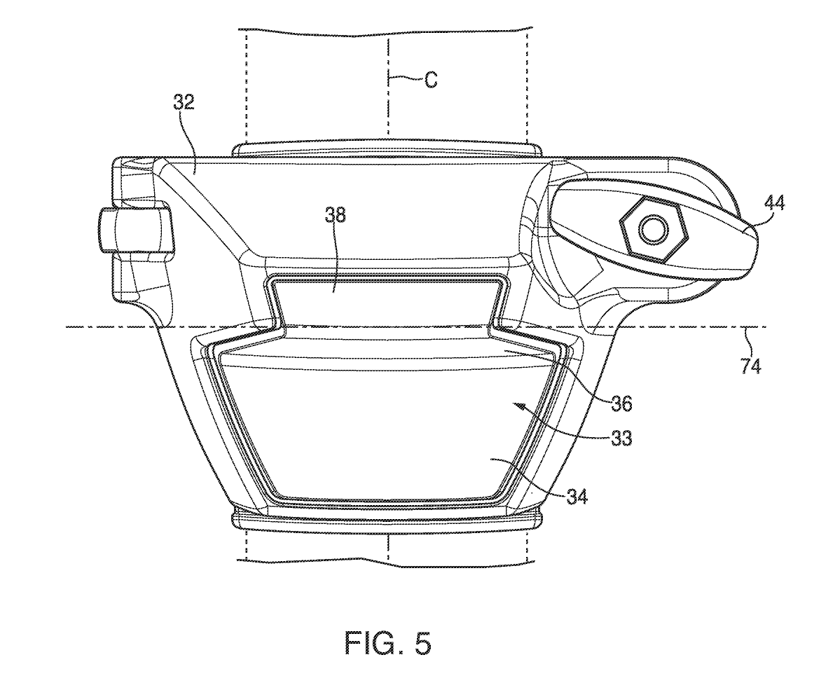

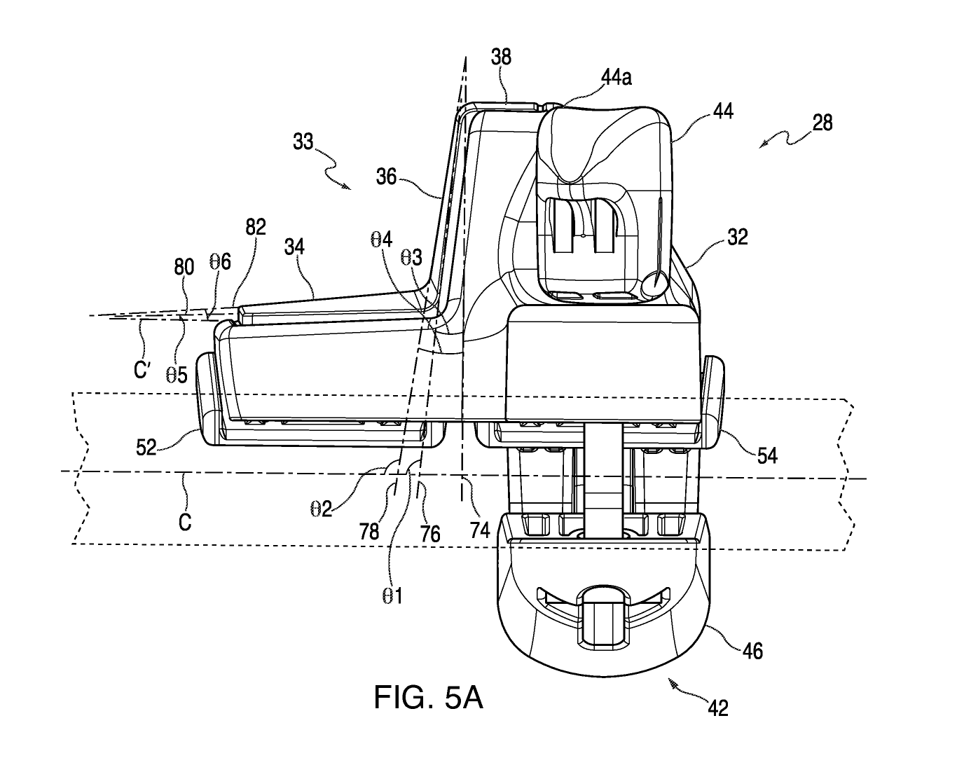

FIG. 5 shows a top view of gunwale bracket mechanism 28. As shown, top surface 38 may be tapered such that a portion of top surface 38 proximal back wall surface 36 may be narrower than a portion of top surface 38 distal back wall surface 36, which may provide an increased frictional force between top surface 38 and the gunwale (or other boat portion) to help prevent the boat from sliding over gunwale support device 32 opposite bench 33. As shown, back wall surface 36 may be convexly curved with a relatively large radius of curvature originating opposite a vertical plane 74 from the back wall surface 36. The large radius of curvature may originate in a location vertically aligned over the core axis of the crossbar. Back wall surface 36 may have a progressive curvature corresponding to a curved portion of a cone. For example, the radius of curvature of back wall surface 36 proximal floor surface 34 may be larger than the radius of curvature of back wall surface 36 distal floor surface 34, which may provide an increase in contact and/or an increased frictional force between the gunwale and back wall surface 36 as the user moves the gunwale towards floor surface 34 along back wall surface 36.

Vertical plane 74 may be substantially vertical, and may be substantially perpendicular to core axis C. As shown, actuator 44 may be disposed above the crossbar and opposite vertical plane 74 from seat surface 34 and back wall surface 36, which may allow the user to rest their hand on an uppermost surface of actuator 44 (i.e., creating a force on the user's hand in the opposite direction to that of gravity) while manipulating actuator 44 without either the user's hand or actuator 44 contacting a side of the boat supported by bench 33.

FIG. 5A shows a side view of gunwale bracket mechanism 28. Seat 34 may be cantilevered inward from clamp device 42. For example, seat 34 projects over the crossbar away from clamp device 42, which secures gunwale bracket 28 to the crossbar, as shown in FIG. 5A.

Seat surface 34 and/or back wall surface 36 may include any suitable structure configured to support a gunwale that may misaligned (or may not be perpendicularly aligned) with gunwale support device 32, core axis C, and/or vertical plane 74. For example, back wall surface 36 may form a non-perpendicular angle with core axis C and/or a non-parallel angle with plane 74; seat surface 34 may form a non-perpendicular angle with plane 74 and/or a non-parallel angle with core axis C; and back wall surface 36 may form an obtuse angle with seat surface 34.

As shown, back 36 may form an obtuse angle with core axis C of the crossbar, which may approximately measure 95-100 degrees. For example, lateral edges of back wall surface 36 may define a plane 76 (shown as being normal to the view) that may form an angle θ1 with core axis C; and a middle portion of back wall surface 36 may define a plane 78 (shown as being normal to the view) that may form an angle θ2 with core axis C. FIG. 5A shows θ1 as being approximately 95 degrees, and θ2 as being approximately 98 degrees.

As shown, back 36 may form an acute angle with plane 74. For example, plane 76 may form an angle θ3 with plane 74; and plane 78 may form an angle θ4 with plane 74. FIG. 5A shows θ3 as being approximately 5 degrees, and θ4 as being approximately 8 degrees.

As shown, seat 34 may form an acute angle with core axis C, which may approximately measure 2-10 degrees. For example, lateral edges of seat surface 34 may define a plane 80 (shown as being normal to the view) that may form an angle θ5 with core axis C (line C′ is parallel to core axis C); and a middle portion of seat surface 34 may define a plane 82 (shown as being normal to the view) that may form an angle θ6 with core axis C. FIG. 5A shows θ5 as being approximately 3 degrees, and θ6 as being approximately 6 degrees.

Gunwale bracket mechanism 28 may be configured to allow for manipulation of actuator 44 while a portion of the boat rests on seat surface 34, back wall surface 36, and/or top surface 38. For example, an uppermost surface 44a of actuator 44 may be disposed vertically below an uppermost portion of top surface 38, and may be disposed vertically below both in the open and clamped positions. As shown, actuator 44 may be disposed above the crossbar, and a portion of bench 33 and actuator 44 may be disposed on opposite sides of a center plane, such as either of planes 74, 76, and/or 78.

Gunwale bracket mechanism 28 may include any structure, mechanism, and/or apparatus configured to support a gunwale both in the open and clamped positions. For example, second pad portion 54 may be opposite core axis C of the crossbar from bail 46, and first pad portion 52 may be under seat 34 when bail 46 is fastened to the crossbar. A majority of seat 34 may be directly over first pad portion 52, a majority of second pad portion 54 may be directly over bail 46; and a majority of bail 46 may be directly under second pad portion 54. As shown, all of seat 34 may be directly over first pad portion 52.

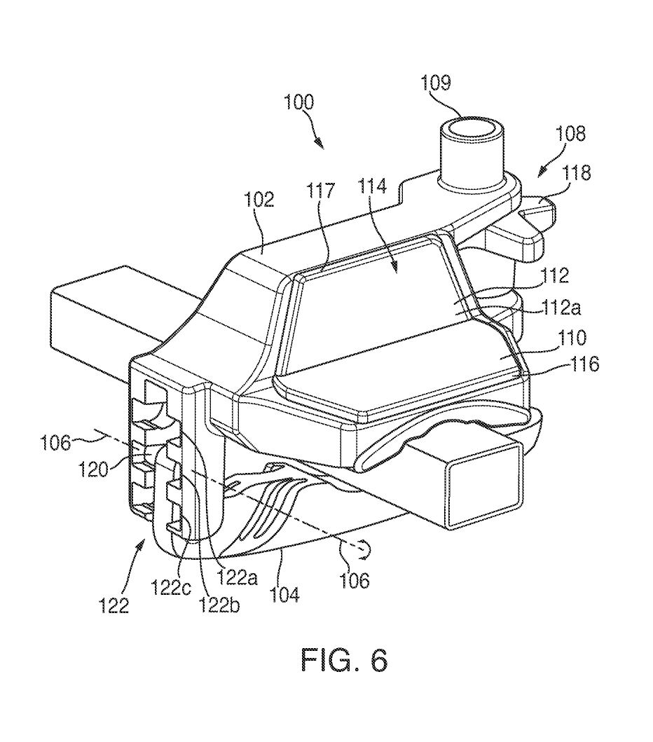

FIG. 6 shows a perspective view of an alternative embodiment of a gunwale bracket mechanism 100 secured to a rectangular crossbar. Gunwale bracket 100 may include a gunwale support device 102 connected to a bail 104 by a pivot axis 106 and a fastener 108. As shown, gunwale support device 102 may include a chimney 109.

Gunwale support device 102 may include a seat surface 110 and a back wall surface 112 that may form a bench 114 for supporting a gunwale of a boat. As shown, seat surface 110 and back wall surface 112 may be substantially perpendicular, and seat surface 110 may be adjacent to a lower portion 112a of back wall surface 112. However, seat surface 110 and back wall surface 112 may form an obtuse angle.

Surfaces 110 and 112 may be surfaces of gunwale support device 102 or may be surfaces of one or more pad portions connected to gunwale support device 102. As shown in FIG. 6, surfaces 110 and 112 are surfaces of compressible pad portions 116, 117 fixedly attached to gunwale support device 102. Compressible pad portions 116, 117 may be made of rubber, or any other suitable compressible material. In contrast, gunwale support device 102 may be made of a substantially rigid material, such as plastic.

Actuation of fastener 108, such as turning of an actuator 118 (shown here as a knob), may cause pivotation of bail 104 in relation to gunwale support device 102 about pivot axis 106 to move bail 104 between open and clamped positions. The open position may correspond to gunwale bracket mechanism 100 being slideable on the crossbar, and the clamped position may correspond to gunwale bracket mechanism 100 being secured on the crossbar (e.g., gripping the crossbar). For example, FIG. 6 shows gunwale bracket mechanism 100 in the clamped position.

As shown in FIG. 6, pivot axis 106 may be parallel to the crossbar and may connect gunwale support device 102 to bail 104 on an opposite side of the crossbar from fastener 108, and a majority of bail 104 may be below the crossbar. Bench 114 and actuator 118 may be disposed above the crossbar. Back wall surface 112 may define a substantially vertical plane, and actuator 118 and a portion of bench 114 may be disposed on opposite sides of that plane.

Pivot axis 106 may include an enlarged member, such as a bar 120, dimensioned to be selectively inserted into any one slot of a plurality of slots 122, such as slots 122a-c, forming an adjustable pivot axis. Bar 120 is shown inserted in slot 122b, but bar 120 may be inserted into slot 122a or 122c in order to accommodate securing gunwale bracket mechanism 100 to a crossbar of a different shape and/or size. For example, the adjustable pivot axis may allow gunwale bracket mechanism 28a to be selectively secured to a round crossbar, a square crossbar, a rectangular crossbar, a curved crossbar, an oval crossbar, a tear-drop shaped crossbar, or any other suitably shaped and/or sized crossbar. While FIG. 6 shows plurality of slots 122 as including three slots, gunwale bracket mechanism 100 may include more or less slots for receiving the enlarged member.

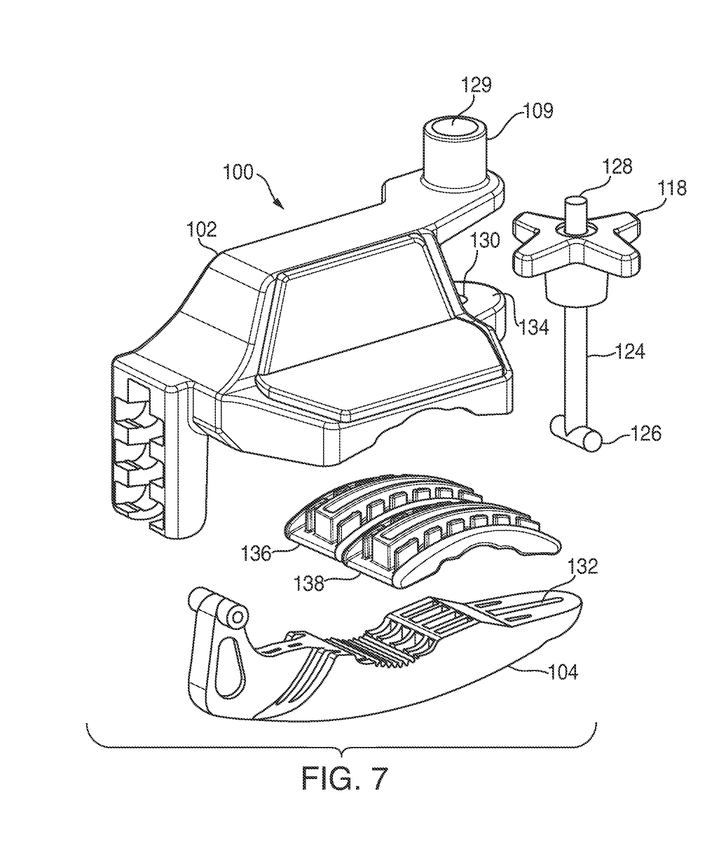

FIG. 7 shows an exploded perspective view of gunwale bracket mechanism 100 highlighting fastener 108 as including actuator 118 operatively connected to a threaded post 124 and to a t-bar 126. A distal end 128 of threaded post 124 may be housed in chimney 109, which may protect the gunwale from being scratched by distal end 128. Chimney 109 may have an aperture 129 with a diameter suitable for receiving t-bar 126.

Gunwale support device 102 may include an aperture 130 alignable with an aperture 132 formed in bail 104, so that t-bar 126 may be inserted through both apertures 130, 132. T-bar 126 may then be turned and seated in a recess (not shown), similar to recess 66 (see FIG. 3A), such that threaded post 124 may extend through apertures 130, 132 and actuator 118 may be disposed between chimney 109 and a substantially planar region 134 of gunwale support device 102.

Apertures 130, 132 may be similar to apertures 62, 64 (see FIG. 3). For example, apertures 130, 132 may be elongate or otherwise shaped to receive t-bar 126. Aperture 132 may be more elongate than aperture 130, such that fastener 118 may be inserted through apertures 130, 132 during various states of pivotation of bail 104.

Actuation of actuator 118 may cause threaded post 124 to move up and down, which may cause bail 104 to pivot toward and away from gunwale support device 102, to move gunwale bracket mechanism 100 between the open and clamped positions.

First and second pad portions 136, 138 may be similarly configured to gunwale bracket mechanism 100 as first and second pad portions 52, 54 are to gunwale bracket mechanism 28. For example, first and second pad portions 136, 138 may be similarly contoured to selectively grip a variety of crossbar shapes and sizes, such as a round crossbar, a rectangular crossbar, a square crossbar, and an aerodynamically shaped crossbar, among others.

Based on the above description and the associated drawings, the following examples further describe various embodiments of apparatuses and methods of the disclosure.

A first illustrative apparatus for carrying a boat may include a crossbar having a core axis, a pair of towers for coupling the crossbar in an orientation perpendicular to an elongate axis of a vehicle, and a clamp device coupled to a gunwale support device.

The gunwale support device may include a bench portion that may have a seat substantially parallel to the core axis of the crossbar, and a back that may define a center plane substantially perpendicular to the core axis of the crossbar.

The clamp device may be configured to grip the crossbar. The seat of the bench portion and the clamp device may be on opposite sides of the center plane. The clamp device may include an actuator located above the crossbar for manipulating the clamp device between open and clamped positions. The actuator may be a knob.

The back may form an angle with the center plane of approximately 5-10 degrees, and the seat may form an angle with the core axis of the crossbar of approximately 5-10 degrees. The seat may have a progressive curvature corresponding to a curved portion of a cone. The back may have a progressive curvature corresponding to a curved portion of a cone.

The clamp device may include a bail pivotally connected to the gunwale support device by a pivot axis. The actuator may be opposite the core axis of the crossbar from the pivot axis. Manipulating the clamp device between open and clamped positions may involve pivotation of the bail about the pivot axis.

The clamp device may include a first pad portion, a second pad portion, and a bale for fastening the pad portions against the crossbar. The first pad portion may be opposite the core axis of the crossbar from the bale. The second pad portion may be under the seat in contact with the crossbar when the bale is fastened.

A second illustrative apparatus for carrying a boat may include a crossbar having a core axis, a pair of towers for coupling the crossbar in an orientation perpendicular to an elongate axis of a vehicle, and a clamp device coupled to a gunwale support device and configured to grip the crossbar.

The gunwale support device may include a back wall surface substantially perpendicular to the core axis of the crossbar. The back wall surface may have an upper portion and a bottom portion. The gunwale support device may include a seat surface extending from the bottom portion of the back wall surface substantially parallel to the core axis of the crossbar, and a top surface extending from the upper portion of the back wall surface.

The gunwale support device may include a compressible pad layer running continuously along the seat surface, back wall surface, and top surface. The compressible pad layer may be made of elastomer.

The top surface may extend substantially parallel to the core axis of the crossbar. The top surface may be opposite a plane substantially perpendicular to the core axis of the crossbar from the seat surface.

The back wall surface may form an angle with the core axis of the crossbar of approximately 95-100 degrees, and the seat surface may form an angle with the core axis of the crossbar of approximately 5-10 degrees. The back wall surface may form an obtuse angle with the seat surface.

The clamp device may include an actuator located above the crossbar for manipulating the clamp device between open and clamped positions. The clamped position may grip the crossbar. The actuator may be located opposite the plane from the seat.

An uppermost surface of the actuator may be disposed vertically below an uppermost portion of the top surface in both the open and clamped positions.

A third illustrative apparatus for carrying a boat may include a crossbar having a core axis, a pair of towers for coupling the crossbar in an orientation perpendicular to an elongate axis of a vehicle, and a clamp device coupled to a gunwale support device and configured to grip the crossbar.

The gunwale support device may include a bench portion. The bench portion may have a seat substantially parallel to the core axis of the crossbar, and a back that may define a center plane substantially perpendicular to the core axis of the crossbar.

The clamp device may be configured to grip the crossbar. The clamp device may include a first pad portion, a second pad portion, and a bale for fastening the pad portions against the crossbar. The first pad portion may be opposite the core axis of the crossbar from the bale. The second pad portion may be under the seat in contact with the crossbar when the bale is fastened.

The back may form an angle with the center plane of approximately 5-10 degrees. The seat may form an angle with the core axis of the crossbar of approximately 5-10 degrees. The seat may be convexly curved. The back may be convexly curved.

A majority of the seat may be directly over the second pad portion. The first and second pad portions may be made of rubber having a coefficient of friction greater than 1.

The bail may be pivotally connected to the gunwale support device by a pivot axis. The clamp device may include an actuator located above the crossbar for pivoting the bail to fasten the pad portion against the crossbar. The pivot axis may include an enlarged member selectively insertable into any one slot of a plurality of slots, which may form an adjustable pivot axis.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. An apparatus for carrying a boat comprising:
a crossbar having a core axis, and a pair of towers for coupling the crossbar in an orientation perpendicular to an elongate axis of a vehicle;
a gunwale support device including a bench portion having a seat substantially parallel to the core axis of the crossbar, and a back defining a center plane substantially perpendicular to the core axis of the crossbar; and
a clamp device coupled to the gunwale support device, configured to grip the crossbar, wherein the seat of the bench portion and the clamp device are on opposite sides of the center plane, and an actuator located above the crossbar for manipulating the clamp device between open and clamped positions.

2. The apparatus of claim 1, wherein the back forms an angle with the center plane of approximately 5-10 degrees, and the seat forms an angle with the core axis of the crossbar of approximately 5-10 degrees.

3. The apparatus of claim 1, wherein the seat has a progressive curvature corresponding to a curved portion of a cone.

4. The apparatus of claim 1, wherein the back has a progressive curvature corresponding to a curved portion of a cone.

5. The apparatus of claim 1, wherein the clamp device includes a bail pivotally connected to the gunwale support device by a pivot axis, the actuator being opposite the core axis of the crossbar from the pivot axis, and manipulating the clamp device between open and clamped positions involves pivotation of the bail about the pivot axis.

6. The apparatus of claim 5, wherein the clamp device includes a first pad portion, a second pad portion, and a bale for fastening the pad portions against the crossbar, the first pad portion being opposite the core axis of the crossbar from the bale, the second pad portion being under the seat in contact with the crossbar when the bale is fastened.

7. An apparatus for carrying a boat comprising:
a crossbar having a core axis, and a pair of towers for coupling the crossbar in an orientation perpendicular to an elongate axis of a vehicle;
a gunwale support device including a back wall surface substantially perpendicular to the core axis of the crossbar, the back wall surface having an upper portion and a bottom portion, a seat surface extending from the bottom portion of the back wall surface substantially parallel to the core axis of the crossbar, and a top surface extending from the upper portion of the back wall surface, and a compressible pad layer running continuously along the seat surface, back wall surface, and top surface; and
a clamp device coupled to the gunwale support device, configured to grip the crossbar.

8. The apparatus of claim 7, wherein the compressible pad layer is made of elastomer.

9. The apparatus of claim 7, wherein the top surface extends substantially parallel to the core axis of the crossbar, the top surface being opposite a plane substantially perpendicular to the core axis of the crossbar from the seat surface.

10. The apparatus of claim 7, wherein the back wall surface forms an angle with the core axis of the crossbar of approximately 95-100 degrees, and the seat surface forms an angle with the core axis of the crossbar of approximately 5-10 degrees.

11. The apparatus of claim 10, wherein the back wall surface forms an obtuse angle with the seat surface.

12. The apparatus of claim 7, wherein the clamp device includes an actuator located above the crossbar for manipulating the clamp device between open and clamped positions, the clamped position gripping the crossbar.

13. The apparatus of claim 12, wherein an uppermost surface of the actuator is disposed vertically below an uppermost portion of the top surface in both the open and clamped positions.

14. An apparatus for carrying a boat comprising:
a crossbar having a core axis, and a pair of towers for coupling the crossbar in an orientation perpendicular to an elongate axis of a vehicle;
a gunwale support device including a bench portion having a seat substantially parallel to the core axis of the crossbar, and a back defining a center plane substantially perpendicular to the core axis of the crossbar; and
a clamp device coupled to the gunwale support device, configured to grip the crossbar, including a first pad portion, a second pad portion, and a bale for fastening the pad portions against the crossbar, wherein the first pad portion is opposite the core axis of the crossbar from the bale, the second pad portion being under the seat in contact with the crossbar when the bale is fastened.

15. The apparatus of claim 14, wherein the back forms an angle with the center plane of approximately 5-10 degrees, and the seat forms an angle with the core axis of the crossbar of approximately 5-10 degrees.

16. The apparatus of claim 14, wherein both the seat and the back are convexly curved.

17. The apparatus of claim 14, wherein a majority of the seat is directly over the second pad portion.

18. The apparatus of claim 14, wherein the first and second pad portions are made of rubber having a coefficient of friction greater than 1.

19. The apparatus of claim 14, wherein the bail is pivotally connected to the gunwale support device by a pivot axis, and the clamp device includes an actuator located above the crossbar for pivoting the bail to fasten the pad portion against the crossbar.

20. The apparatus of claim 19, wherein the pivot axis includes an enlarged member selectively insertable into any one slot of a plurality of slots forming an adjustable pivot axis.
